(19) United States
(12) Patent Application Publication
(10) Pub. No.: US 2009/0009793 A1
(43) Pub. Date: Jan. 8, 2009

(54) IMAGE FORMING APPARATUS AND IMAGE FORMING METHOD

(75) Inventors: Hidekazu Ozawa, Ebina-shi (JP); Akihito Toyoda, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 11/943,917

(22) Filed: Nov. 21, 2007

(30) Foreign Application Priority Data
Jul. 5, 2007 (JP) 2007-177322

(51) Int. Cl. G06F 15/00

(52) U.S. Cl. 358/1.15

(57) ABSTRACT

An image forming apparatus includes a display that displays a normal operational screen and information other than the normal operational screen; an alert information creating unit that creates alert information for making a user aware of a trouble occurring; and a display controller that, upon a trouble occurring when information other than the normal operational screen is displayed on the display, operates to display the alert information created by the alert information creating unit on the display, keeping at least some of the information other than the normal operational screen displayed.

### CROSS-REFERENCE TO RELATED APPLICATIONS

This application is based on and claims priority under 35 USC 119 from Japanese Patent Application No. 2007-177322 filed Jul. 5, 2007.

### BACKGROUND

1. Technical Field

The present invention relates to an image forming apparatus and image forming method for displaying information other than a normal operational screen, such as advertising information.

2. Related Art

Recently, image forming apparatuses such as copiers and printers are installed not only at offices but also in public places where general public often come in, such as convenience stores, libraries, and city halls. A display attached to the image forming apparatus to display an operational screen becomes larger. Consequently, some image forming apparatuses become capable of displaying information other than a normal operational screen on its display to make effective use of the display.

However, this manner of displaying advertising information has a problem that the advertising display area is too small if advertising is intended to be viewed by a wide cross section of people.

There is another image forming apparatus adapted to display advertising information in the front of its display screen while no user action takes place, and switch the screen to the display of a normal operation screen when the user is going to use the image forming apparatus. In this mode of displaying advertising information or other information in the front of the display screen, it is necessary to return what is displayed on the display from the advertising information to the normal operational screen when the user is going to use the image forming apparatus.

Therefore, a switch control method is used, whereby display is controlled as follows: for example, when the user performs a predefined action while displaying advertising information or other information, what is being displayed is switched to the normal operational screen; upon the elapse of a predetermined period of time during which no user action occurs, the operational screen is switched to a display of advertising information or other information.

In the image forming apparatus, in case a trouble (fault) such as paper jam, paper out, a communication error, or a hardware malfunction occurs, a fault screen (alert information) is displayed on the display. Generally, the fault screen display takes precedence over any other display, because it is urgent to make the user aware of such a trouble and let the user to take some action to eliminate the trouble. Such a fault screen continues to be displayed until the trouble has been eliminated. Thus, a continued display of such a fault screen, after appearing during a display of advertising, prevents the viewer of the advertising from obtaining information.

### SUMMARY

An image forming apparatus according to an aspect of the invention includes a display that displays a normal operational screen and information other than the normal operational screen; an alert information creating unit that creates alert information for making a user aware of a trouble occurring; and a display controller that, upon a trouble occurring when information other than the normal operational screen is displayed on the display, operates to display the alert information created by the alert information creating unit on the display, keeping at least some of the information other than the normal operational screen displayed.

### BRIEF DESCRIPTION OF THE DRAWINGS

An exemplary embodiment of the present invention will be described in detail based on the following figures, wherein:

FIG. 1 is a system schematic diagram showing a framework of an image processing system for an exemplary embodiment of the invention;

FIG. 2 is an enlarged outside view of an image forming apparatus 10 of an exemplary embodiment of the invention;

FIG. 3 is a block diagram depicting a hardware structure of the image forming apparatus 10 of an exemplary embodiment of the invention;

FIG. 4 is a block diagram depicting an arrangement of functions of the image forming apparatus 10 of an exemplary embodiment of the invention;

FIGS. 5A and 5B are illustrations to explain an example of display switch control by a display controller 52;

FIGS. 6A and 6B illustrate an example of switchover control between a normal operational screen and advertising information on the display 11;

FIG. 7 illustrates an example of a screen that is displayed on the display 11, when setting an alert information display manner by an alert information display manner setting part 54;

FIG. 8 illustrates an example of a screen that is displayed on the display 11 when setting a fault indication manner by the alert information display manner setting part 54;

FIG. 9 illustrates an example of a screen that is displayed on the display 11, when specifying a job for which an alert information display manner is set by the alert information display manner setting part 54;

FIG. 10 illustrates an example of a display of train service information before a trouble occurs;

FIG. 11 illustrates an example of a display of train service information after a trouble occurs;

FIG. 12 illustrates an example of a screen for setting whether to enable or disable automatic recognition of alert information display on/off by the alert information display manner setting part 54, depending on whether or not advertising information displayed on the display 11 is printable; and

FIG. 13 illustrates an example of displaying a message of alert information 71 in the screen of train service information that is printable, if setting is done to enable automatic recognition of alert information display on/off.

### DETAILED DESCRIPTION

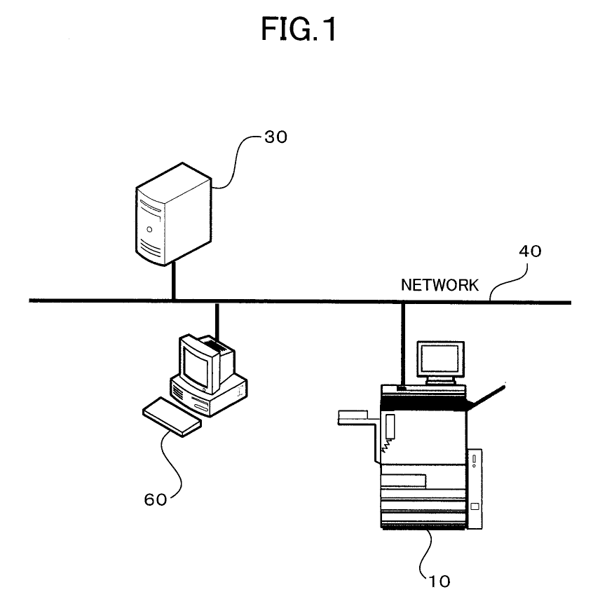

Then, an exemplary embodiment of the invention is described in detail with reference to the drawings. FIG. 1 illustrates a framework of an image processing system for an exemplary embodiment of the invention.

As shown in FIG. 1, the image processing system for the present exemplary embodiment includes an image forming apparatus 10, a terminal device 60, and an advertising information distribution server 30 interconnected via a network 40.

The advertising information distribution server 30 stores a variety of advertising information to be presented on a display of the image forming apparatus 10 and distributes advertising information to the image forming apparatus 10 according to a prearranged procedure. The terminal device 60 generates printing data such as print jobs and transmits such data to the image forming apparatus 10. The image forming apparatus 10 is a complex machine having a printing function, a copying function, a facsimile transmitting/receiving function, and a scanning function. The image forming apparatus 10 receives printing data transmitted from the terminal device 60 and outputs an image corresponding to the printing data on printing paper. Moreover, it displays advertising information distributed from the advertising information distribution server 30 on the display.

In the present exemplary embodiment, the invention is explained for a situation where advertising information is taken as information other than a normal operational screen. Alternatively, the invention can be applied in the same way for other situations where information other than advertising information, such as information about train service, nearby sightseeing information, and event information, is displayed as information other than the operational screen on the display of the image forming apparatus 10.

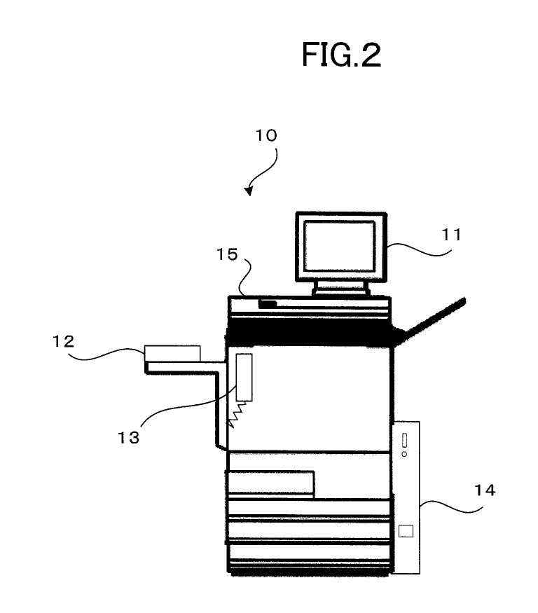

Next, an enlarged outside view of the image forming apparatus 10 of the present exemplary embodiment is shown in FIG. 2. The image forming apparatus 10 of the present exemplary embodiment, as shown in FIG. 2, includes a display 11 for displaying a normal operational screen and advertising information, an authentication device 12, a telephone set 13, a billing device 14, and a paper tray 15.

The authentication device 12 authenticates a user who has an authentication card by reading identification information from the authentication card on which such information has already been stored, such as, for example, a contactless IC card. The telephone set 13 is linked to a public telephone line and can be used as an ordinary telephone. When the facsimile function of the image forming apparatus 10 is used, the user may first make a call to a destination over the telephone line, using the telephone set 13, and, after making sure of the connection to the destination, send facsimile data.

The billing device 14 is a device for billing a user who uses the apparatus without authentication for using the image forming apparatus 10. The billing device 14 is arranged to allow a user who paid a fee by slotting in a coin to use the image forming apparatus 10 to a limit set for the fee paid. Because of provision of this billing device 14, the functions of the image forming apparatus 10 are also available to a user who does not have an authentication card.

The paper tray 15 is a tray to set an original to be copied, a page to be scanned by a scanner, or a page to fax in it.

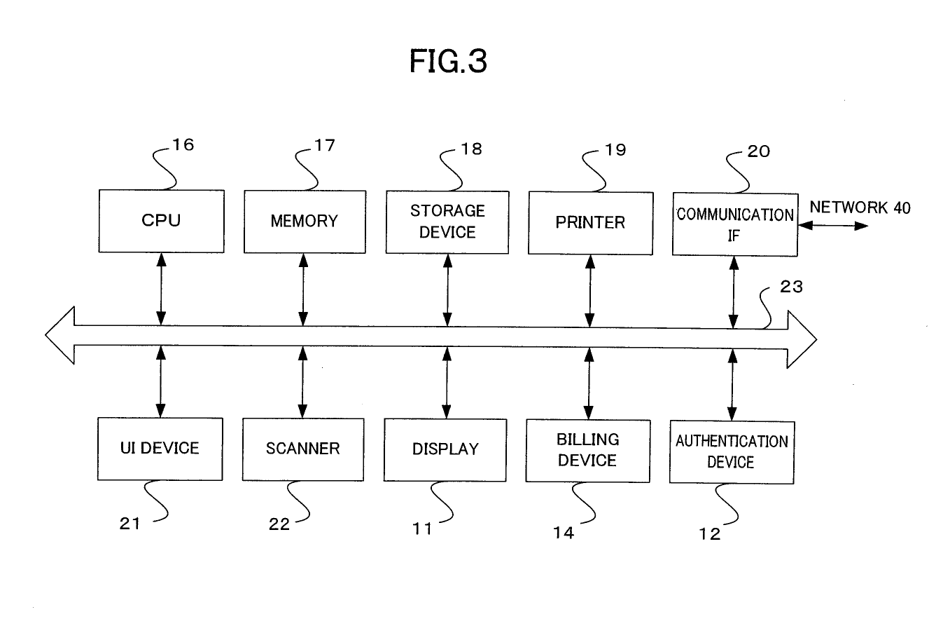

Next, a hardware structure of the image forming apparatus 10 of the present exemplary embodiment is shown in FIG. 3.

The image forming apparatus 10, as shown in FIG. 3, includes a CPU 16, a memory 17, a storage device 18 such as a hard disk drive (HDD), a printer 19, a communication interface (IF) 20 which transmits and receives data to/from a remote machine such as the advertising information distribution server 30, terminal device 60, and the like via the network 40, a user interface (UI) device 21 including a touch panel, manual operation buttons or indicator lamps, and the like, a scanner 22, a display 11, a billing device 14, and an authentication device 12. These components are interconnected via a control bus 23.

The CPU 16 executes predetermined processing based on an image processing program stored in the memory 17 or the storage device 18 and controls the operation of the image forming apparatus 10.

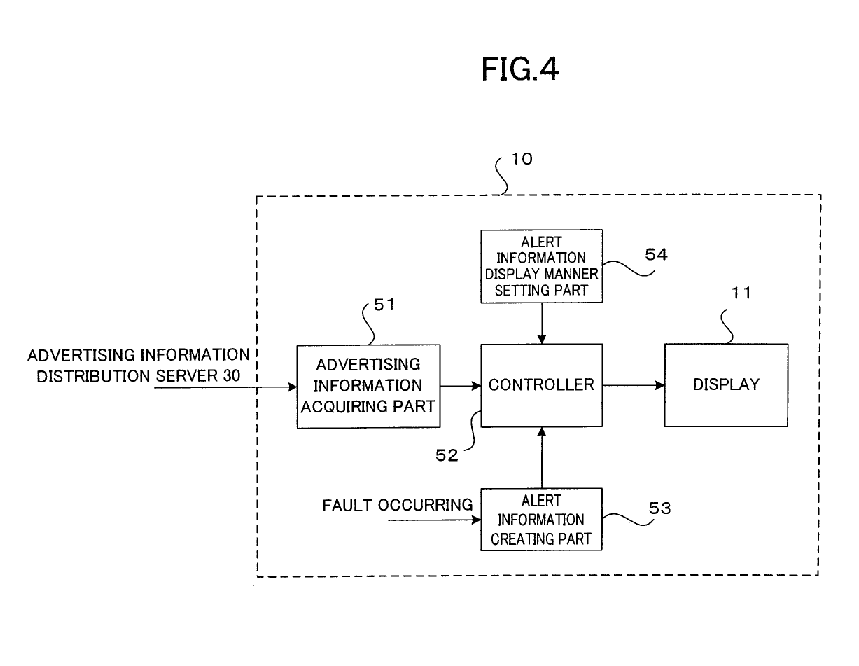

FIG. 4 is a block diagram depicting an arrangement of functions of the image forming apparatus 10, which are realized by executing the image processing program.

The image forming apparatus 10 of the present exemplary embodiment, as shown in FIG. 4, is provided with an advertising information acquiring part 51, a display controller 52, an alert information creating part 53, an alert information display manner setting part 54, and a display 11.

The advertising information acquiring part 51 acquires advertising information distributed from the advertising information distribution server 30 via the network 40.

The display controller 52 generates image data for advertising information to display, acquired by the advertising information acquiring part 51, by use of application software such as a WWW (World Wide Web) browser. Also, the display controller 52 generates image data for a normal operational screen to display for operating the image forming apparatus 10 by use of application software such as the WWW browser.

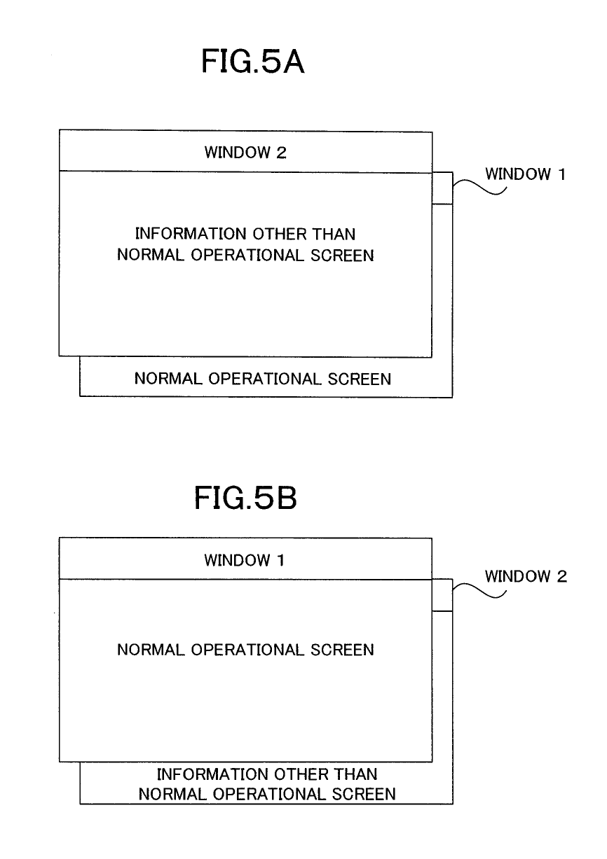

The display controller 52 performs display control to switch what is displayed on the display 11 between the advertising information and the normal operational screen. Referring to FIGS. 5A and 5B, display switch control by the controller 52 is explained.

As shown in FIGS. 5A and 5B, Window 1 to display the normal operational screen and Window 2 to display information other than the normal operational screen, such as advertising information, are prepared in advance. By changing the window displayed to the fore, the display controller switches what is displayed on the display 11.

For example, in FIG. 5A, the display controller 52 displays Window 2 where information other than the normal operational screen is displayed to the fore over Window 1. Thereby, information other than the normal operational screen is displayed on the display 11. In this state, when Window 1 is displayed to the fore, then the normal operation screen is displayed on the display 11.

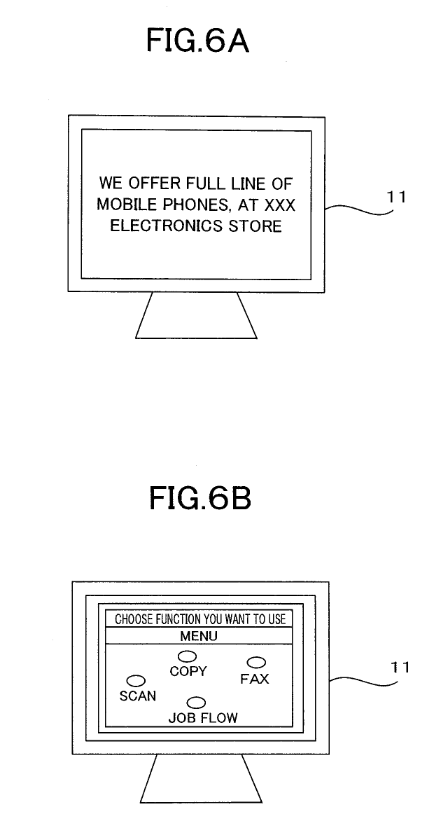

An example of switchover between the normal operational screen and information other than the normal operational screen performed on the display 11 is shown in FIGS. 6A and 6B.

FIG. 6A is an illustration depicting an example of advertising information “We offer full line of mobile phones, at XXX Electronics Store” displayed on the display 11. FIG. 6B is an illustration depicting an example of the normal operational screen, a menu screen for choosing any of the functions of the image forming apparatus 10, displayed on the display 11.

In case a trouble (fault) such as paper jam, paper out, an communication error, hardware malfunction, or the like occurs in the image forming apparatus 10, the alert information creating part 53 creates alert information (fault screen) to make the user aware of the trouble.

Upon a trouble occurring when advertising information is displayed on the display 11, the display controller 52 operates to display alert information created by the alert information creating part 53 on the display 11, keeping at least some of the advertising information displayed.

Specifically, the alert information display manner setting part 54 sets a display manner of displaying alert information on the display 11. The display controller 52 displays alert information created by the alert information creating part 53 on the display 11, based on the display manner set by the alert information display manner setting part 54.

In this case, the alert information display manner setting part 54 sets an alert information display manner for each type of job specified, such as copy, remote print job (printer job) requested by the terminal device 60, or print job requested by user action on the image forming apparatus 10. In addition, the alert information display manner setting part 54 sets an alert information display manner for each type of trouble occurred, such as paper jam, paper out, communication error, or hardware malfunction.

Instead of displaying alert information, keeping at least some of the advertising information displayed, the display controller 52 may operate not to display alert information created by the alert information creating part 53 upon a trouble occurring when advertising information is information is displayed on the display 11.

In this case, specifically, the alert information display manner setting part 54 sets whether or not to display alert information on the display 11. The display controller 52 may or may not display alert information created by the alert information creating part 53 on the display 11, according to a setting made by the alert information display manner setting part 54.

In this case, the alert information display manner setting part 54 sets whether or not to display alert information for each type of job specified, such as copy, printer job, or print job. In addition, the alert information display manner setting part 54 sets whether or not to display alert information for each type of trouble occurred, such as paper jam, paper out, communication error, or hardware malfunction. Moreover, the alert information display manner setting part 54 sets whether or not to display alert information, depending on whether or not the advertising information displayed on the display 11 is printable.

Next, the operation of the image forming apparatus 10 of the present exemplary embodiment is explained with reference to the drawings.

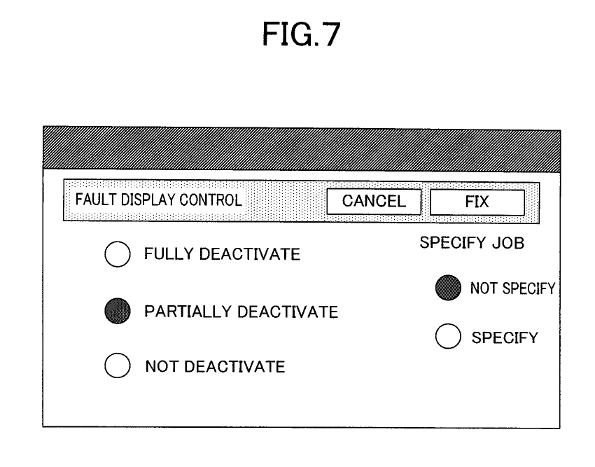

An example of a screen that is displayed on the display 11 when setting an alert information display manner by the alert information display manner setting part 54 is shown in FIG. 7.

In the example shown in FIG. 7, it is illustrated that selection can be made among options “fully deactivate”, “partially deactivate”, and “not deactivate” as a manner of displaying alert information (fault display).

Here, “fully deactivate” means that, even if any trouble (fault) occurs during a display of advertising information, displaying alert information is fully deactivated, that is, alert information is not displayed at all. In other words, if “fully deactivate” is selected, the display controller 52 operates not to display alert information created by the alert information creating part 53 on the display 11, even if a trouble occurs, when advertising information is displayed on the display 11.

Then, “partially deactivate” means that, if any trouble occurs during a display of advertising information, displaying alert information is partially deactivated. That is, switching of the normal operational screen to alert information does not occur but a display of alert information is restricted to make the content of advertising information viewable. In other words, if “partially deactivate” is selected, upon a trouble occurring during a display of advertising information on the display 11, the display controller 52 operates to display alert information on the display 11, keeping at least some of the advertising information displayed on the display 11. There are several ways of providing alert information to the user; such as LED light up, sounding a buzzer, displaying a message, and audible notification.

Further, “not deactivate” means that, if any trouble occurs during a display of advertising information, alert information is displayed and the display of the normal operational screen is stopped.

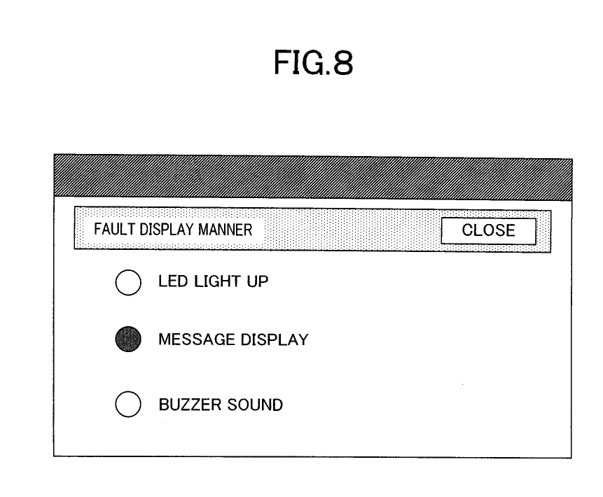

In a case where “partially deactivate” is selected in the screen shown in FIG. 7, a screen as illustrated in FIG. 8 is provided to allow the user to select among options as to how to provide alert information.

In the example shown in FIG. 8, if “LED light up” is selected, alert information is not displayed within the screen of the display 11. Instead, by lighting up an LED provided separately from the display 11, the user is alerted of a trouble occurring.

In the example shown in FIG. 8, if “message display” is selected, alert information is displayed as a message within the display of advertising information on the display 11.

Further, in the example shown in FIG. 8, if “buzzer sound” is selected, alert information is not displayed within the screen of the display 11. Instead, by sounding a buzzer provided separately from the display 11, the user is alerted of a trouble occurring.

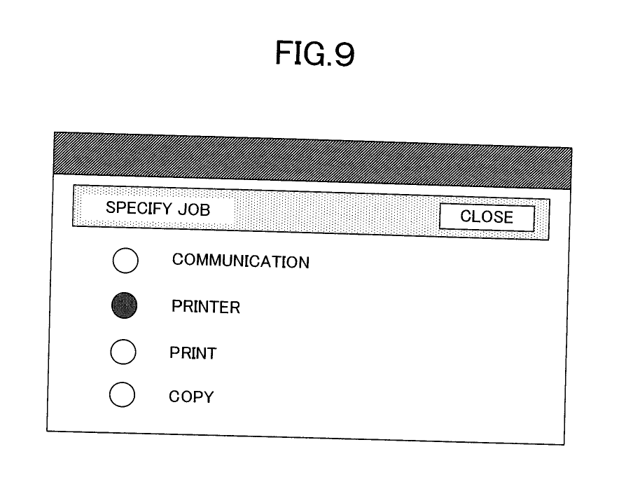

The screen shown in FIG. 7 allows the user to set whether or not to display alert information and a display manner that is used if alert information is displayed for each job. Although “specify job” is set to “not specify” in the example shown in FIG. 7, if “specify” is selected for “specify job”, a screen as illustrated in FIG. 9 is provided to allow the user to specify a job.

In the example shown in FIG. 9, a “printer” job is selected as a job for which alert information is “partially deactivated”. In the case of this selection made, setting is done to partially deactivate alert information with regard to a trouble occurring during the execution of a print job (printer job) transmitted from the terminal device 60.

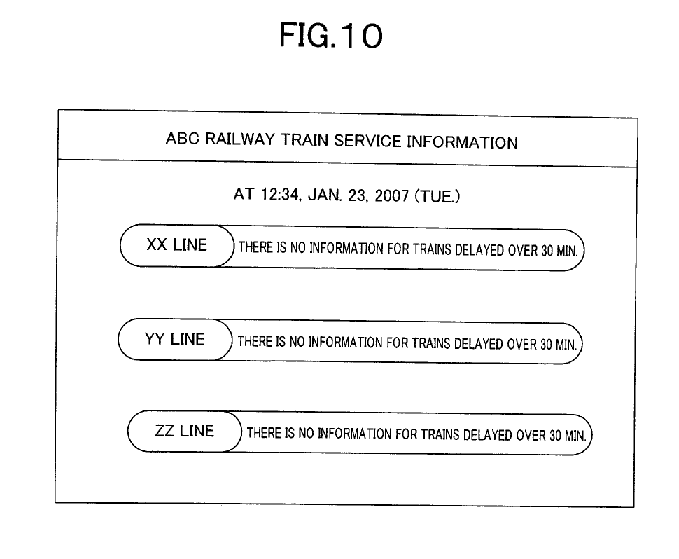

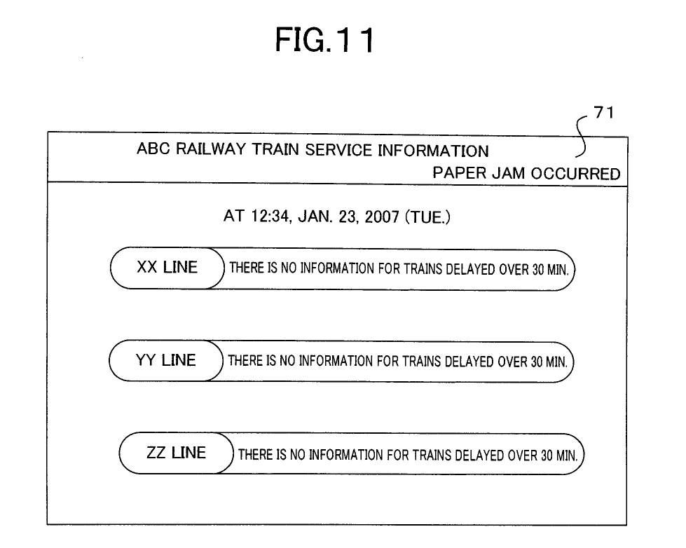

Next, on the assumption that “partially deactivate” is selected as a manner of display control of alert information and “message display” is selected as a manner of providing alert information, an example of a display of alert information is illustrated in FIGS. 10 and 11. Here, an instance where train service information is displayed instead of advertising information is discussed.

If paper jam occurs when train service information is displayed on the display 11, as illustrated in FIG. 10, alert information 71 “paper jam occurred” is displayed on the display 11 without interfering with the display of the train service information, as illustrated in FIG. 11.

By displaying such alert information 71, it is possible to make the user aware of paper jam occurring without interfering with the display of train service information.

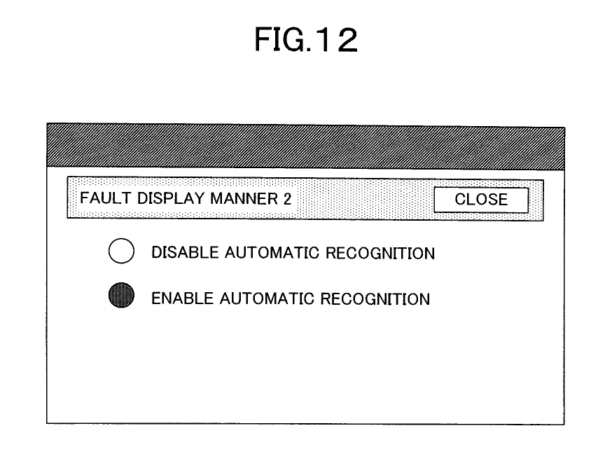

Next, FIG. 12 illustrates an example of a screen for setting whether to enable or disable automatic recognition of alert information display on/off by the alert information display manner setting part 54, depending on whether or not advertising information displayed on the display 11 is printable.

In the setting screen shown in FIG. 12, if “enable automatic recognition” is selected, the alert information display manner setting part 54 automatically recognizes whether or not advertising information displayed on the display 11 is printable. If such information is printable, the alert information display manner setting part 54 sets alert information display on; if not, it sets alert information display off.

In fact, if the advertising information is printable, the printing function may fail to operate properly due to any trouble occurring and, therefore, alert information display is set on. If the advertising information is not printable, alert information display is set off, because it is not needed to alert the user by displaying information as to whether or not the printing function operates properly.

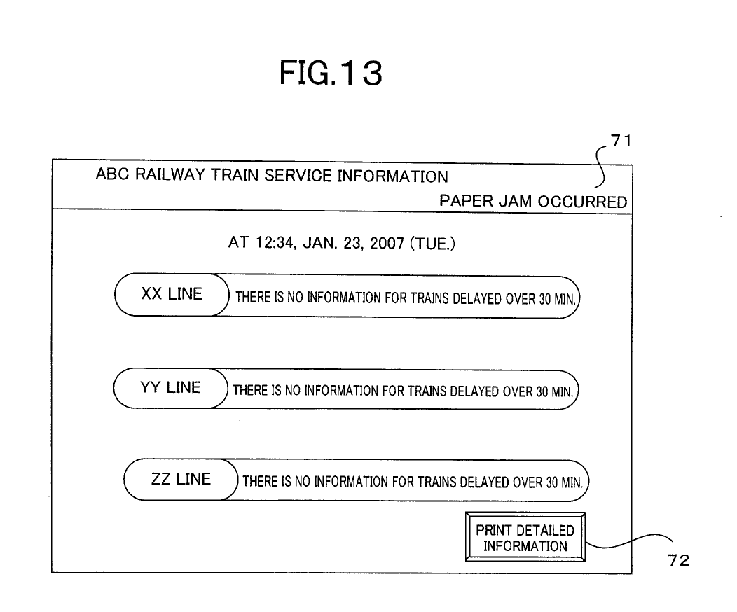

If “enable automatic recognition” is selected in the setting screen as shown in FIG. 12, a print run button 72 labeled “Print Detailed Information” is incorporated in the display of train service information, as illustrated in FIG. 13. Only if this train service information is printable, a message of alert information 71 “paper jam occurred” is displayed. If the train service information is not printable, no message of alert information 71 is displayed.

If the printing function fails to operate properly because of any trouble occurring, it may be possible to hide the print run button 72 instead of displaying the alert information 71.

The present invention may be embodied in other specific forms without departing from its spirit or characteristics. The described exemplary embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. An image forming apparatus comprising:
a display that displays a normal operational screen and information other than the normal operational screen;
an alert information creating unit that creates alert information for making a user aware of a trouble occurring; and
a display controller that, upon a trouble occurring when information other than the normal operational screen is displayed on the display, operates to display the alert information created by the alert information creating unit on the display, keeping at least some of the information other than the normal operational screen displayed.

2. The image forming apparatus according to claim 2, further comprising:
a setting unit that sets a display manner of displaying alert information on the display;
wherein the display controller operates to display alert information created by the alert information creating unit on the display, based on the display manner set by the setting unit.

3. The image forming apparatus according to claim 2, wherein the setting unit sets an alert information display manner for each type of job specified.

4. The image forming apparatus according to claim 2, wherein the setting unit sets an alert information display manner for each type of trouble occurred.

5. An image forming apparatus comprising:
a display that displays a normal operational screen and information other than the normal operational screen;
an alert information creating unit that creates alert information for making a user aware of a trouble occurring; and
a display controller that, upon a trouble occurring when information other than the normal operational screen is displayed on the display, operates not to display alert information created by the alert information creating unit on the display.

6. The image forming apparatus according to claim 5, further comprising:
a setting unit that sets whether or not to display alert information on the display;
wherein the display controller operates not to display the alert information created by the alert information creating unit on the display, based on a setting made by the setting unit.

7. The image forming apparatus according to claim 6, wherein the setting unit sets whether or not to display alert information for each type of job specified.

8. The image forming apparatus according to claim 6, wherein the setting unit sets whether or not to display alert information for each type of trouble occurred.

9. The image forming apparatus according to claim 6, wherein the setting unit sets whether or not to display alert information, depending on whether or not information other than the normal operational screen displayed on the display is printable.

10. An image forming method comprising:
displaying information other than a normal operational screen;
creating alert information for making a user aware of a trouble occurring; and
operating to display the alert information on the display, keeping at least some of the information other than the normal operational screen displayed, upon a trouble occurring when information other than the normal operational screen is displayed on the display.

11. An image forming method comprising:
displaying information other than a normal operational screen;
creating alert information for making a user aware of a trouble occurring; and
operating not to display the alert information on the display, upon a trouble occurring when information other than the normal operational screen is displayed on the display.
